(19) United States
(12) Patent Application Publication
(10) Pub. No.: US 2003/0121591 A1
(43) Pub. Date: Jul. 3, 2003

(54) Method of joining substrates of flat plate display element

(76) Inventor: Sung Ju Kim, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/309,952

(22) Filed: Dec. 4, 2002

(30) Foreign Application Priority Data
Dec. 31, 2001 (KR) 2001-89259

(51) Int. Cl. C03C 27/00

(52) U.S. Cl. 156/99

(57) ABSTRACT

Disclosed is a method of joining substrates of a flat plate display element, which can remarkably reduce a circumferential area of the flat plate display element, which cannot perform the display function, and employs an adhesive made from the same material as that of the glass substrates, thereby being capable of obtaining a strong adhesive force between the glass substrates. The method comprises the steps of: preparing two glass substrates; aligning and overlapping the two glass substrates to and on each other; applying an adhesive material onto sides of the overlapping glass substrates; and fusing and solidifying the adhesive material applied on the sides of the glass substrates, thereby joining the glass substrates.

### BACKGROUND OF THE INVENTION

1. Field of the invention

The present invention relates to a method for manufacturing a flat plate display element, and more particularly to a method of joining upper and lower glass substrates constituting a flat plate display element.

2. Description of the Prior Art

Hereinafter, a conventional method of joining substrates of a flat plate display element will be described with reference to FIGS. 1 to 3.

FIGS. 1 to 3 are views showing the conventional method of joining substrates of a flat plate display element.

In the conventional method of joining substrates of a flat plate display element, as shown in FIG. 1, two sheets of transparent substrates 1 and 11, on which thin film, devices, and other materials are formed, are first prepared. Then, an adhesive material 13 for joining the two transparent substrates 1 and 11 is supplied by an adhesive supply device 10 and is applied onto any one substrate 11 of the two substrates.

Then, as shown in FIG. 2, the two substrates 1 and 11 are aligned and attached to each other.

Finally, as shown in FIG. 3, the attached two substrates 1 and 11 are heated so that the adhesive material 13 can be solidified.

As described above, a conventional flat plate display element is made through joining and sealing two sheets of transparent substrates between which proper adhesive materials required according to characteristics of each device is inserted.

During the sealing process of the conventional method, a circumferential area, which cannot perform the display function, is formed at the edge portion of the flat plate display element.

Further, a predetermined amount of adhesive material is injected to the space between the two transparent substrates in order to obtain a sufficient adhesive force after the two transparent substrates are joined. In this case also, the injected adhesive material forms another circumferential area which cannot perform the display function.

These inferior areas become useless spaces around the display area in a final product, and large differences are produced in the size of products as display elements grow smaller.

Therefore, it is considered to be very important to reduce the useless circumferential areas at the edges of the flat plate display element, and continuous efforts and studies are made to reduce these areas. However, conventional technologies are limited in reducing the useless circumferential areas because an adequate area should be secured for the adhesive materials to properly join the upper and lower substrates.

### SUMMARY OF THE INVENTION

Accordingly, the present invention has been made to solve the above-mentioned problems occurring in the prior art, and an object of the present invention is to provide a method of joining substrates of a flat plate display element, which can remarkably reduce a circumferential area of the flat plate display element, which cannot perform the display function, and employs an adhesive made from the same material as that of the glass substrates, thereby being capable of obtaining a strong adhesive force between the glass substrates.

In order to accomplish this object, there is provided a method of joining substrates of a flat plate display element, the method comprising the steps of: preparing two glass substrates; aligning and overlapping the two glass substrates to and on each other; applying an adhesive material onto sides of the overlapping glass substrates; and fusing and solidifying the adhesive material applied on the sides of the glass substrates, thereby joining the glass substrates.

Preferably, the adhesive material is in the form of paste containing glass powder. Also, the fusing and solidifying step may comprise the steps of: fusing the adhesive material by supplying light energy to the adhesive material; and solidifying the adhesive material by stopping supply of the light energy.

### BRIEF DESCRIPTION OF THE DRAWINGS

The above and other objects, features and advantages of the present invention will be more apparent from the following detailed description taken in conjunction with the accompanying drawings, in which:

FIGS. 1 to 3 are views illustrating a conventional method of joining substrates of a flat plate display element; and

FIGS. 4 to 6 are views illustrating a process of joining substrates of a flat plate display element in accordance with the present invention.

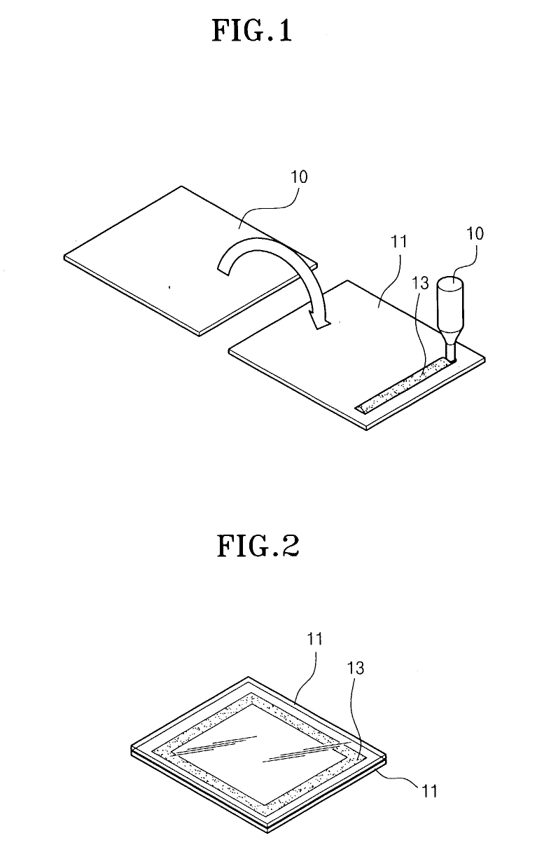

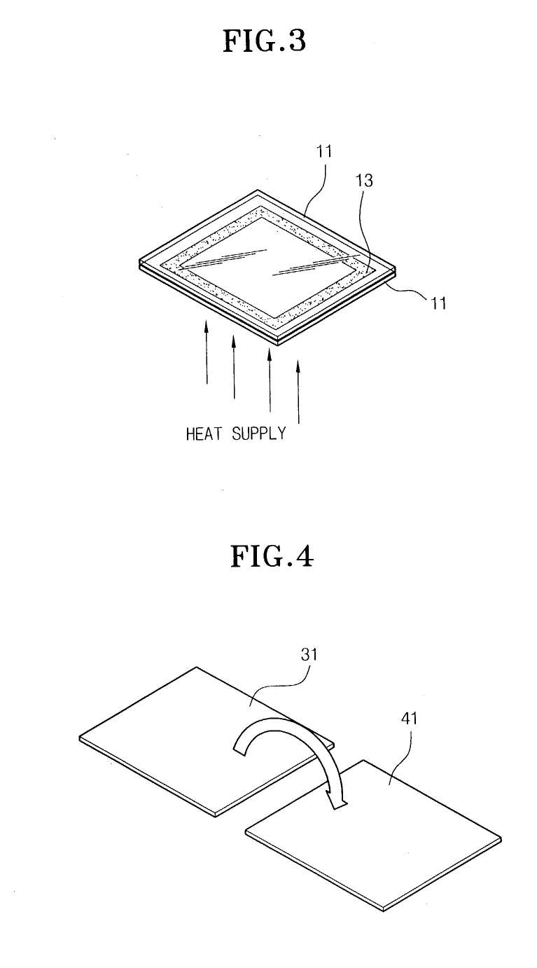

### DETAILED DESCRIPTION OF THE PREFERRED EMBODIMENTS

Hereinafter, a preferred embodiment of the present invention will be described with reference to the accompanying drawings.

FIGS. 4 to 6 are views showing a process of joining substrates of a flat plate display element in accordance with the present invention.

In the method of joining substrates of a flat plate display element according to the present invention, as shown in FIG. 4, firstly two glass substrates 31 and 41 are prepared, and thin films, devices, other materials, etc., are formed on the substrates before the substrates are joined together. That is, existing glass substrates employed in the conventional flat plate display element are used as the two glass substrates, and the process of producing the substrate before joining the substrates is the same as that in the conventional production method, excepting that the process of pasting the adhesive material on the substrate before joining the two substrates 31 and 41 is omitted.

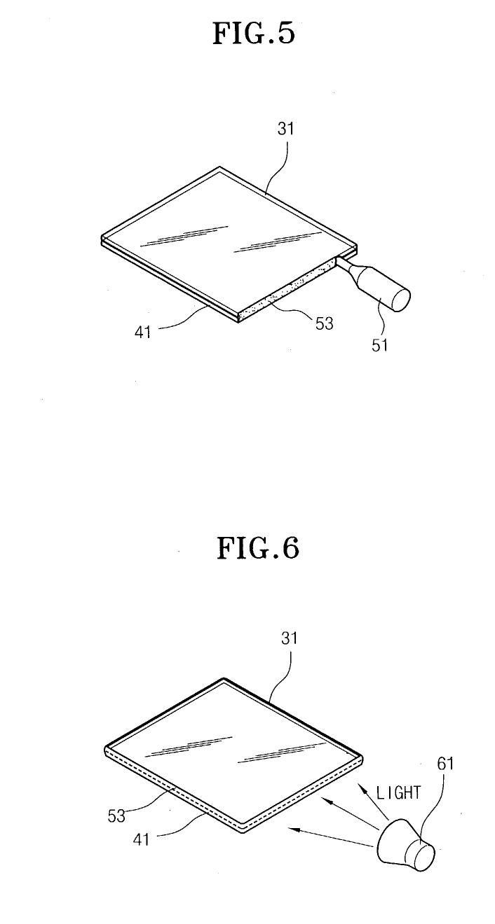

Thereafter, as shown in FIG. 5, after the above treatment for the two glass substrates 31 and 41 has been completed, the two glass substrates 31 and 41 are moved to a joining position and aligned to each other.

Next, after the substrates 31 and 41 are aligned to and overlapped on each other at the joining position, an adhesive material 53 is squeezed from a nozzle (not shown) of the adhesive supply device 51 to be applied to sides of the two facing substrates 31 and 41 overlapped on each other with a fine space therebetween. In this case, the adhesive material 53 is in the form of paste and is fused and solidified by a light energy in the following process, so as to join the substrates 31 and 41. In this case, it is preferred that the paste of the adhesive material contains glass powders to enable complete attachment of the glass substrates.

Finally, as shown in FIG. 6, light energy is supplied to corresponding regions of the substrates by a light energy supply device 61, after the process of applying the adhesive material, so as to fuse the adhesive material 53, and then the supply of light energy is stopped to solidify the adhesive material, thereby joining the two substrates 31 and 41.

Hereinafter, the effects of the present invention will be described.

As described above, in the method of joining substrates of a flat plate display element according to the present invention, pastes containing glass powders are applied to sides of the two overlapped substrates and then are fused and solidified by the light energy, instead of the conventional method of joining substrates in which an adhesive material is applied between the substrates. Therefore, in the method of joining substrates of a flat plate display element according to the present invention, circumferential area which cannot perform the display function can be remarkably reduced and strong adhesive forces can be obtained due to the adhesive made from the same material as that of the two glass substrates.

Further, in the method according to the present invention, chemical reaction between the adhesive material and the material of the two substrates is prevented, so that inferior products can be prevented from being produced due to the chemical reaction.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of joining substrates of a flat plate display element, the method comprising the steps of:
preparing two glass substrates;
aligning and overlapping the two glass substrates to and on each other;
applying an adhesive material onto sides of the overlapping glass substrates; and
fusing and solidifying the adhesive material applied on the sides of the glass substrates, thereby joining the glass substrates.

2. The method of joining substrates of a flat plate display element as claimed in claim 1, wherein the adhesive material is in the form of paste containing glass powder.

3. The method of joining substrates of a flat plate display element as claimed in claim 1, wherein the fusing and solidifying step comprises the steps of:
fusing the adhesive material by supplying light energy to the adhesive material; and
solidifying the adhesive material by stopping supply of the light energy.
